(19) United States
(12) Patent Application Publication
(10) Pub. No.: US 2003/0092491 A1
(43) Pub. Date: May 15, 2003

(54) Game medium management system for managing game media

(75) Inventors: Jun Fujimoto, Tokyo (JP); Nobuyuki Nonaka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corporation, Tokyo (JP)

(21) Appl. No.: 10/289,256

(22) Filed: Nov. 7, 2002

(30) Foreign Application Priority Data
Nov. 9, 2001 (JP) 2001-344210

(51) Int. Cl. A63F 13/00

(52) U.S. Cl. 463/42

(57) ABSTRACT

A game medium management system of the present invention allows the prevention of use of a forged game medium and enables track of missing game medium to be kept. The game medium management system includes a medium ID information storage device 15 provided in a game medium 1 for storing medium ID information uniquely identifying the game medium 1, a medium ID information reader 61 for reading the medium ID information stored in the medium ID information storage device 15, a medium ID information manager 32 for managing the medium ID information assigned to the game medium 1, a verifying unit for verifying the medium ID information read by the medium ID information reader 61 against the medium ID information managed by the medium ID information manager 32, and a sorter 63 for sorting the game medium 1 as an invalid game medium when the verifying unit 31 ascertains disagreement between the medium ID information read by the medium ID information reader 61 and the medium ID information managed by the medium ID information manager 32.

### CROSS REFERENCE TO RELATED APPLICATION

This application is based upon and claims the benefit of priority from the prior Japanese Patent Application No.P2001-344210, filed on; the entire contents of which are incorporated herein by reference

### BACKGROUND OF THE INVENTION

1. Field of the Invention

This invention relates to a game medium management system for managing game media used as a substitute for money.

2. Description of the Related Art

In order to prevent forgery of game media having values equal to money, managers managing game media have taken conventional measures such as subjecting the game media to various processing into their patterns and shapes. The managers managing the game media manage information on the kinds of the game media, the number of the game media and so on.

This allows the managers managing the game media to keep track of the use state of the game media and the use of forged game media.

It is, however, difficult to distinguish forged game media from authentic game media because the number of game media simultaneously handled is great. Also game media can be easily taken away and forged.

### BRIEF SUMMARY OF THE INVENTION

The present invention has been made in view of the above problems and has an object of providing a game medium management system which allows the prevention of use of forged game media and enables track of missing game media to be kept.

According to a first aspect of the present invention, there is provided a game medium management system for managing a game medium used as a substitute for money, which system comprises: a medium ID information storage device provided in the game medium, the storage device storing medium ID information uniquely identifying the game medium; a medium ID information reader for reading the medium ID information stored in the medium ID information storage device; a medium ID information manager for managing the medium ID information assigned to the game medium; a verifying unit for verifying the medium ID information read by the medium ID information reader against the medium ID information managed by the medium ID information manager; and a sorter for sorting the game medium as an invalid game medium when the verifying unit ascertains disagreement between the medium ID information read by the medium ID information reader and the medium ID information managed by the medium ID information manager.

According to a second aspect of the present invention, the game medium management system in the first aspect of the invention further comprises: a medium manager for managing medium management information in which the medium ID information is read by the medium ID information reader, reader ID information uniquely identifies the medium ID information reader having read the medium ID information, and the result of the verification by the verifying unit of the read medium ID information against the medium ID information managed by the medium ID information manager are associated with one another; and a display for displaying the medium management information is managed by the medium manager.

According to a third aspect of the present invention, the medium ID information reader in the first aspect of the invention is provided at a game table for use in a game played with the game medium.

According to a fourth aspect of the present invention, the medium ID information in the first aspect of the invention comprises a medium number of a fixed number and a medium ID of a variable number; and the medium number is selected from given sequence numbers.

According to a fifth aspect of the present invention, the medium ID in the fourth aspect of the invention is selected from a table of random numbers.

According to a sixth aspect of the present invention, the game medium management system in the fourth aspect of the invention further comprises: a medium ID selector for selecting the medium ID not managed by the medium ID information manager; and a medium ID information replacing unit for replacing the medium ID stored in the medium ID information storage device with the medium ID selected by the medium ID selector, wherein when the verifying unit ascertains agreement between the medium ID information read by the medium ID information reader and the medium ID information managed by the medium ID information manager, the medium ID included in the medium ID information stored in the medium ID information storage device and the medium ID included in the medium ID information managed by the medium ID information manager are replaced with the medium ID selected by the medium ID selector.

According to a seventh aspect of the present invention, the medium ID information replacing unit in the sixth aspect of the invention replaces the medium ID included in the medium ID information stored in the medium ID information storage device with the medium ID selected by the medium ID selector when the medium ID information stored in the medium ID information storage device is read by the medium ID information reader.

According to an eighth aspect of the present invention, the medium ID selector in the sixth aspect of the invention randomly selects the medium ID not managed by the medium ID information manager.

According to a ninth aspect of the present invention, the medium ID information reader and the sorter in the first aspect of the invention are provided at a collector for collecting the game medium.

According to a tenth aspect of the present invention, the medium ID information reader and the sorter in the first aspect of the invention and the medium ID information replacing unit in the sixth aspect of the invention are provided at a collector for collecting the game medium.

According to an eleventh aspect of the present invention, the game table in the third aspect of the invention is provided with a collector for collecting the game medium and a display for displaying medium management information managed by a medium manager.

### BRIEF DESCRIPTION OF THE SEVERAL VIEWS OF THE DRAWINGS

FIG. 1 is a schematic diagram of a game medium management system according to an embodiment of the present invention;

FIG. 2 is an external view of a game medium in this embodiment;

FIG. 3 is a schematic diagram of the game medium in this embodiment;

FIG. 4 is a diagram illustrating medium ID information in this embodiment;

FIG. 5 is a schematic diagram illustrating game tables in this embodiment;

FIG. 6 is a first schematic diagram illustrating a collector in this embodiment;

FIG. 7 is a second schematic diagram illustrating the collector in this embodiment;

FIG. 8 is a diagram illustrating a game medium identifying unit in this embodiment;

FIG. 9 is a first diagram illustrating a sorter in this embodiment;

FIG. 10 is a second diagram illustrating the sorter in this embodiment,

FIG. 11 is a third diagram illustrating the sorter in this embodiment;

FIG. 12 is a functional block diagram illustrating the game medium management system in this embodiment;

FIG. 13 is a diagram illustrating medium management information in this embodiment;

FIG. 14 is a diagram illustrating a display screen displayed by a display in this embodiment;

FIG. 15 is a diagram illustrating game table information in this embodiment;

FIG. 16 is a flowchart illustrating medium ID information reading in this embodiment;

FIG. 17 is a flowchart illustrating verification in this embodiment;

FIG. 18 is a flowchart illustrating replacement of medium ID information in this embodiment; and

FIG. 19 is a flowchart illustrating replacement of medium ID information in a second modification.

### DETAILED DESCRIPTION OF THE INVENTION

[Configuration of Game Medium Management System]

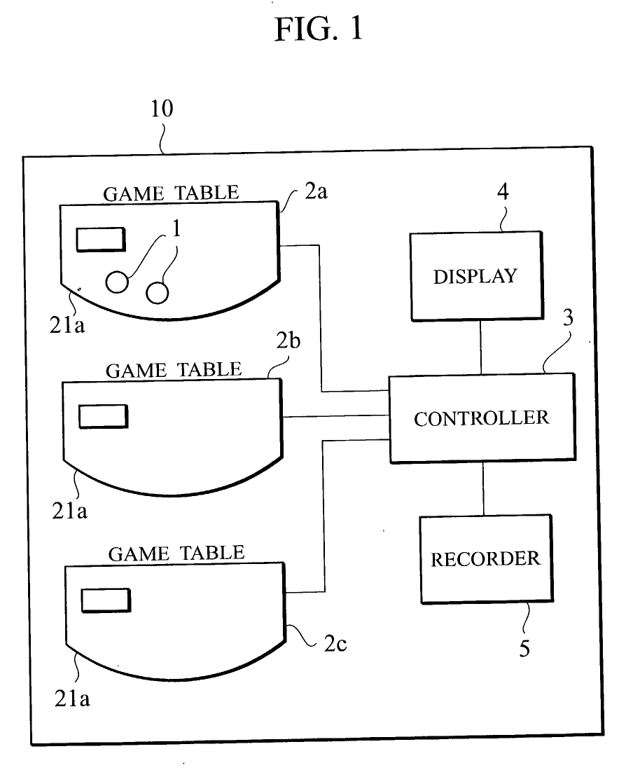

The configuration of an embodiment of the present invention will be described with reference to the drawings. FIG. 1 is a schematic diagram illustrating a game medium management system 10 according to the embodiment. As shown in FIG. 1, the game medium management system 10 manages game media 1 used as substitutes for money. Specifically, the game medium management system 10 includes game tables (2a to 2c), a controller 3, a display 4 and a recorder 5.

The game media 1 are used as substitutes for money. The game media 1 are, for example, chips for use in games (such as poker and roulette) played in casinos. The game media 1 have different shapes in accordance with the substituted amounts of money. The game media 1 are subjected to various processing into their patterns and shapes so as to prevent forgery.

The game media 1 may be colored differently for different players to identify the individual players. The game media 1 may substitute arbitrary amounts of money (e.g., 100 dollars, 1000 dollars and 5000 dollars). The game media 1 corresponding to an amount of money bet are placed on a game table by a player, and a game winner gets them. The game media 1 may be checked out by a game medium exchanger for exchanging money with the game media 1.

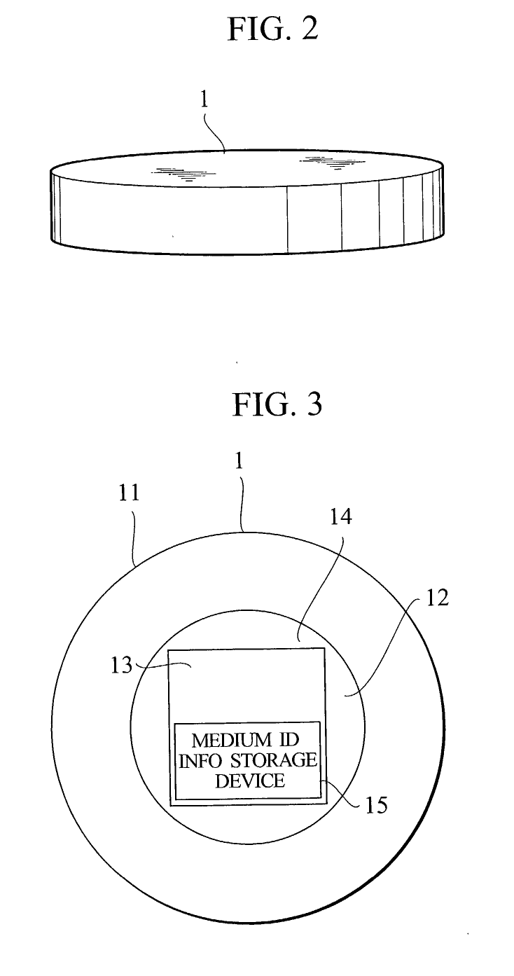

FIG. 2 is an external view illustrating a game medium 1 in this embodiment. FIG. 3 is a schematic view illustrating the game medium in this embodiment. As shown in FIG. 3, the game medium 1 has a plastic portion 11 and a metal portion 12.

The plastic portion 11 is provided around the metal portion 12, being color-coded in accordance with the substituted amount of money.

The metal portion 12 incorporates an IC tag 13. The IC tag 13 includes a transceiver antenna 14 and a medium ID information storage device 15.

The transceiver antenna 14 transmits/receives the medium ID information identifying the game medium 1 to/from a collector 21, using a modulation technique such as ASK. The transceiver antenna 14 is in the form of an antenna coil wound around the IC tag 13 several times in a circular ring shape. The number of winding of the antenna coil is determined based on the functions required.

The medium ID information storage device 15 stores the medium ID information. The medium ID information storage device 15 transmits the medium ID information stored in the medium ID information storage device 15 to the collector 21 via the transceiver antenna 14.

The medium ID information storage device 15 replaces the medium ID information stored in the medium ID information storage device 15 with medium ID information received from the collector 21 via the transceiver 14.

The medium ID information storage device 15 includes, for example, an IC chip, a tuning capacitor, a rectifier diode, a smoothing capacitor and a memory.

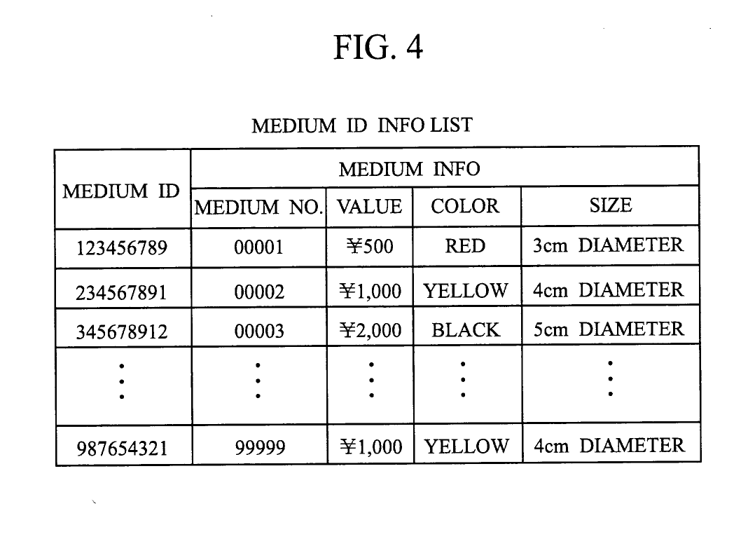

As shown in FIG. 4, the medium ID information includes a medium ID and medium information.

The medium ID is made of a variable number uniquely identifying the game medium 1. The medium ID may be selected from a table of random numbers.

The medium information includes, for example, a medium number, value information, color information and size information.

The medium number is a fixed number uniquely identifying the game medium. The medium number may be selected from given sequence numbers.

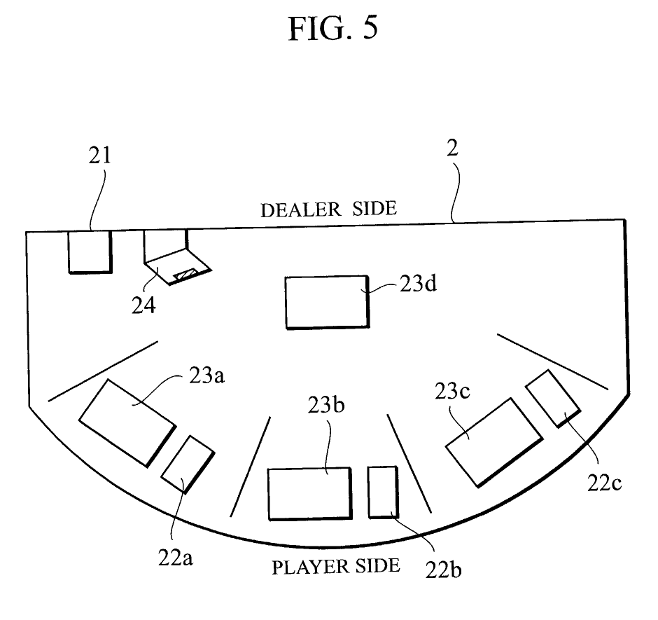

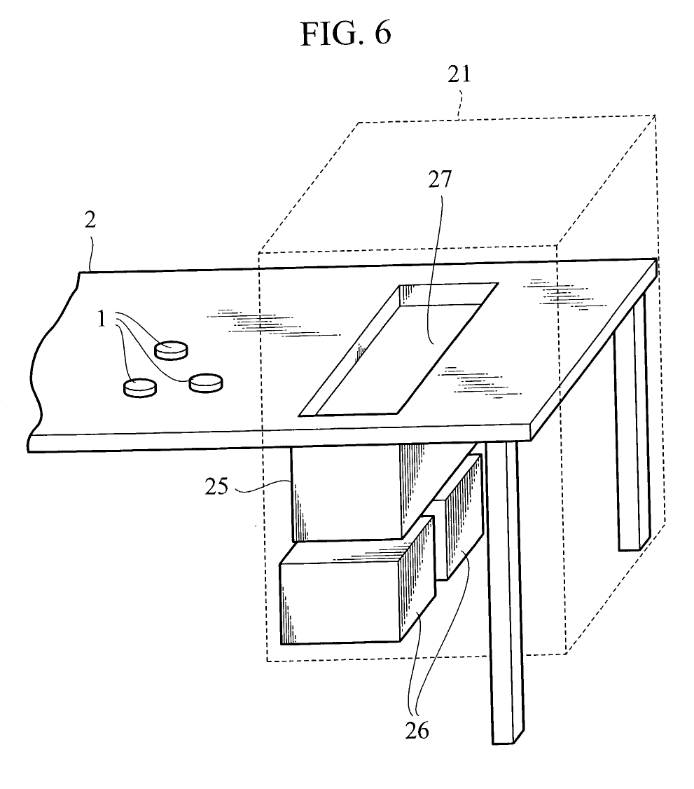

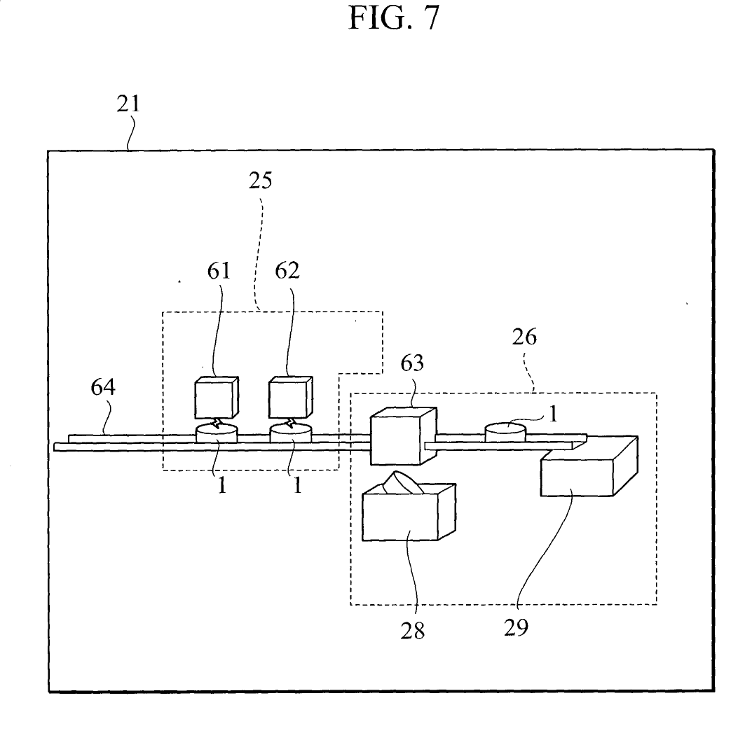

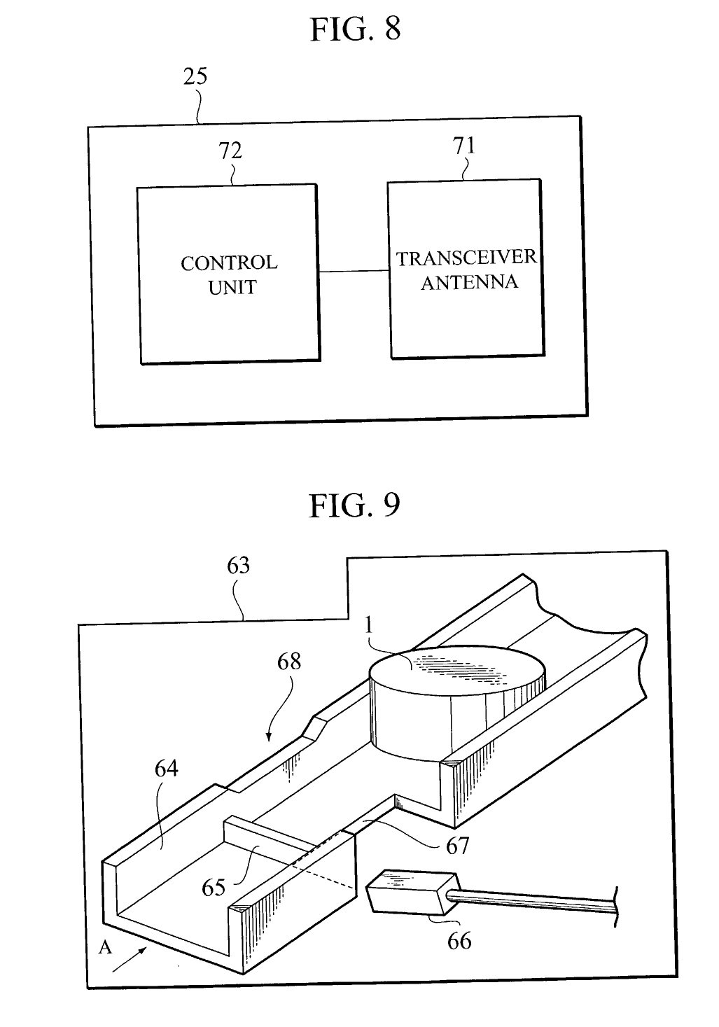

FIG. 5 is a schematic diagram illustrating a game table 2 in this embodiment. FIGS. 6 and 7 are schematic diagrams illustrating the collector 21 in this embodiment. FIG. 8 is a block diagram illustrating a modification of a game medium identifying unit 25 in this embodiment. FIG. 9 is a perspective view illustrating an example of a sorter 63 in this embodiment.

As shown in FIG. 5, the game table 2 includes game medium regions (22a to 22c), game regions (23a to 23d), a card distributor 24 and the collector 21.

The game table 2 is used for a game using game media. In this embodiment, the game (e.g., poker) is played with cards. The game may be roulette, for example. The card game is played by a dealer who deals the cards and three players in competition with one another.

The game medium regions 22 are regions on which the game media 1 corresponding to amounts of money bet for play of the game are placed.

The game regions 23 are regions on which the cards used in the game are placed.

The card distributor 24 houses the cards used in the game. From the card distributor 24, the cards are taken out one by one by the dealer.

The collector 21 collects the game media 1 used in the game. Specifically, as shown in FIGS. 6 and 7, the collector 21 includes a collecting mouth 27, a guiding passage 64, the game medium identifying unit 25 and a game medium collecting unit 26.

The collector 21 is provided at the game table 2. The collector 21 may be provided in a game machine such as a rotating drum game machine. The collector 21 may be provided in an arbitrary place in the game hall provided with the game tables 2 and the like.

From the collecting mouth 27, the game media 1 are collected and fed to the guiding passage 64 one by one. The collecting mouth 27 may be in the form of a hopper.

The guiding passage 64 guides the game media 1 collected from the collecting mouth 27 one by one.

The game medium identifying unit 25 reads the medium ID information stored in the medium ID information storage device 15. The game medium identifying unit 25 replaces the medium ID included in the medium ID information stored in the medium ID information storage device 15 with a medium ID received from the controller 3.

The game medium identifying unit 25 may be provided in a game medium exchanger for exchanging money with the game media 1.

Specifically, the game medium identifying unit 25 includes, as shown in FIG. 7, a medium ID information reader 61 and a medium ID information replacing unit 62.

The medium ID information reader 61 reads the medium ID information stored in the game medium 1 when the game medium reaches a region communicable with the medium ID information reader 61. More specifically, the medium ID information reader 61 receives the medium ID information from the medium ID information storage device 15 provided in the game medium 1, using a modulation technique such as ASK.

The medium ID information reader 61 transmits the medium ID information received from the medium ID information storage device 15 to the controller 3 and the medium ID information replacing unit 62.

The medium ID information reader 61 also transmits to the controller 3 medium location information in which the medium ID information received from the medium ID information storage device 15 is associated with a reader ID information uniquely identifying the medium ID information reader 61 having read the medium ID information.

The medium ID information reader 61 may be provided in an arbitrary place in the game hall (e.g., casino) provided with a plurality of game tables.

The medium ID information replacing unit 62 replaces the medium ID included in the medium ID information stored in the game medium 1 with a medium ID received from the controller 3 when the game medium 1 reaches a region communicable with the medium ID information replacing unit 62.

More specifically, the medium ID information replacing unit 62 replaces the medium ID included in the medium ID information received from the medium ID information reader 61 with a medium ID received from the controller 3 and transmits the medium ID information including the new medium ID to the medium ID information storage device 15, using a modulation technique such as ASK.

The medium ID information replacing unit 62 also transmits the medium ID information including the new medium ID to the controller 3.

The game medium identifying unit 25 may consist, as shown in FIG. 8, of a transceiver antenna 71 and a control unit 72.

The transceiver antenna 71 transmits/receives the medium ID information to/from the transceiver antenna 14 provided in the game medium 1, using a modulation scheme such as ASk when the game medium 1 reaches a region communicable with the transceiver antenna 71.

The control unit 72 reads the medium ID information stored in the game medium 1. More specifically, the control unit 72 receives the medium ID information from the medium ID information storage device 15 via the transceiver antenna 71. The control unit 72 transmits the medium ID information received from the medium ID information storage device 15 to the controller 3.

The control unit 72 replaces the medium ID included in the medium ID information stored in the game medium 1 with a medium ID received from the controller 3.

More specifically, the control unit 72 replaces the medium ID included in the medium ID information received from the medium ID information storage device 15 with a medium ID received from the controller 3 and transmits the medium ID information including the new medium ID to the medium ID information storage device 15.

The control unit 72 also transmits the medium ID information including the new medium ID to the controller 3.

The control unit 72 includes a CPU, a ROM and a RAM. The control unit 72 has functions of recording, processing and outputting, for example.

The game medium collecting unit 26 sorts the game media 1 into invalid game media and valid game media. The game medium collecting unit 26 stores the game media 1 sorted by the game medium collecting unit 26.

More specifically, as shown in FIG. 7, the game medium collecting unit 26 includes an invalid game medium storage 28, a valid game media storage 29 and a sorter 63.

The invalid game medium storage 28 stores the game media 1 sorted as being invalid game media by the sorter 63.

An invalid game medium is a game medium 1 with medium ID information stored in a medium ID information storage device 15 of the game medium disagreeing with the medium ID information managed by the controller 3.

The valid game medium storage 29 stores the game media 1 sorted as being valid game media by the sorter 63.

A valid game medium is a game medium 1 with medium ID information stored in a medium ID information storage device 15 of the game medium agreeing with the medium ID information managed by the controller 3.

The sorter 63 sorts the game media 1 into valid and invalid ones based on signals received from the controller 3. More specifically, as shown in FIG. 9, the sorter 63 includes a stopper 65, a hammer 66, a sorting notch 67 and a dropping notch 68.

The stopper 65 stops the game medium 1 from being guided through the guiding passage 64. The stopper 65 releases the stopping of the game medium 1 based on a signal received from the controller 3.

The hammer 66 flicks out the game medium 1 stopped by the stopper 64 based on a signal received from the controller 3.

The sorting notch 67 is a cut through which the hammer 66 moves to flick out the game medium 1.

The dropping notch 68 is a cut through which the game medium 1 flicked out by the hammer 66 drops.

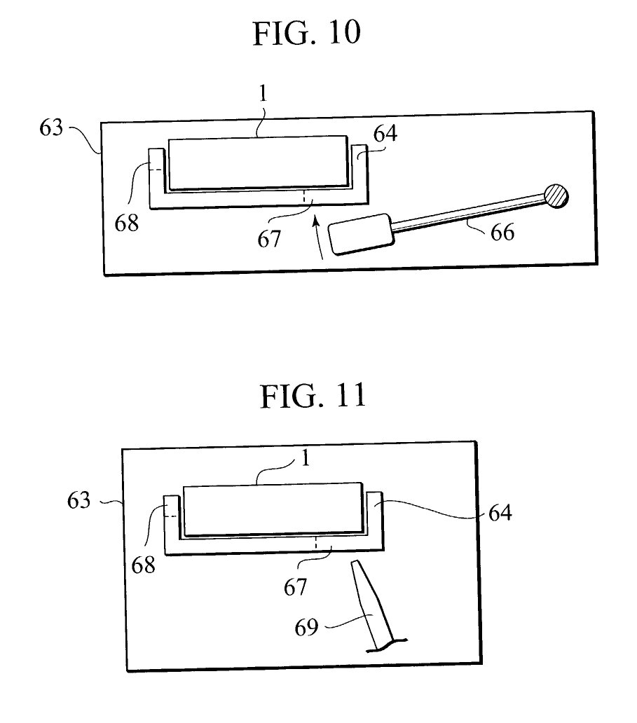

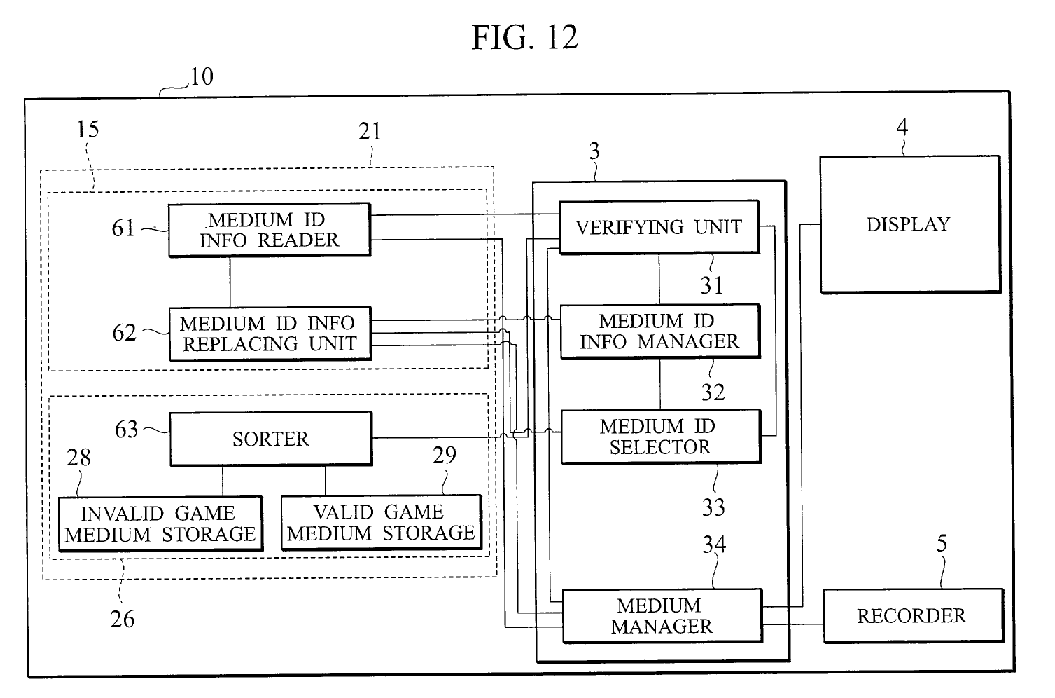

FIGS. 10 and 11 are cross-sectional views of the sorter 63 taken in direction A in FIG. 9.

As shown in FIG. 11, the sorter 63 may have a nozzle 69 in place of the hammer 66. The nozzle 69 flicks out the game medium 1 stopped by the stopper by air pressure based on a signal received from the controller 3.

FIG. 12 is a functional block diagram illustrating the game medium management system 10. The game medium management system 10 includes the collector 21, the controller 3, the display 4 and the recorder 5.

As shown in FIG. 12, the controller 3 includes a verifying unit 31, a medium ID information manager 32, a medium ID selector 33 and a medium manager 34.

The verifying unit 31 verifies the medium ID information received from the medium ID information reader 61 against the medium ID information managed by the medium ID information manager 32.

When agreement between the medium ID information received from the medium ID information reader 61 and the medium ID information managed by the medium ID information manager 32 is ascertained, the verifying unit 31 transmits a validation signal to the medium ID selector 33 and the sorter 63.

When disagreement between the medium ID information received from the medium ID information reader 61 and the medium ID information managed by the medium ID information manager 32 is ascertained, the verifying unit 31 transmits an invalidation signal to the sorter 63.

The verifying unit 31 transmits to the medium manager 34 the result of verification of the medium ID information received from the medium ID information reader 61 against the medium ID information managed by the medium ID information manager 32.

The medium ID information manager 32 manages the medium ID information assigned to the game media 1.

The medium ID information manager 32 retrieves the medium ID information matching the medium ID information received from the medium ID information replacing unit 62 from the medium ID information managed by the medium ID information manager 32. The medium ID information retrieved by the medium ID information manager 32 has the medium number identical to the medium number included in the medium ID information received from the medium ID information replacing unit 62. The medium ID information manager 32 replaces the medium ID included in the medium ID information retrieved by the medium ID information manager 32 with the medium ID included in the medium ID information received from the medium ID information replacing unit 62.

The medium ID selector 33 selects a medium ID not managed by the medium ID information manager 32 when receiving a validation signal from the verifying unit 31. The medium ID selector 33 transmits the medium ID selected by the medium ID selector 33 to the medium ID information replacing unit 62.

The medium manager 34 manages medium management information in which the reader ID information received from the medium ID information reader 61 is associated with the verification result received from the verifying unit 31.

The medium manager 34 retrieves the medium management information matching the medium ID information received from the medium ID information replacing unit 62 from the medium management information managed by the medium manager 34. The medium management information retrieved by the medium manager 34 has a medium number identical to the medium number included in the medium ID information received from the medium ID information replacing unit 62. The medium manager 34 replaces the medium ID included in the medium management information retrieved by the medium manager 34 with the medium ID included in the medium ID information received from the medium ID information replacing unit 62.

When the medium management information managed by the medium manager 34 is replaced, the medium manager 34 transmits the medium management information replaced by the medium manager 34 to the display 4 and the recorder 5.

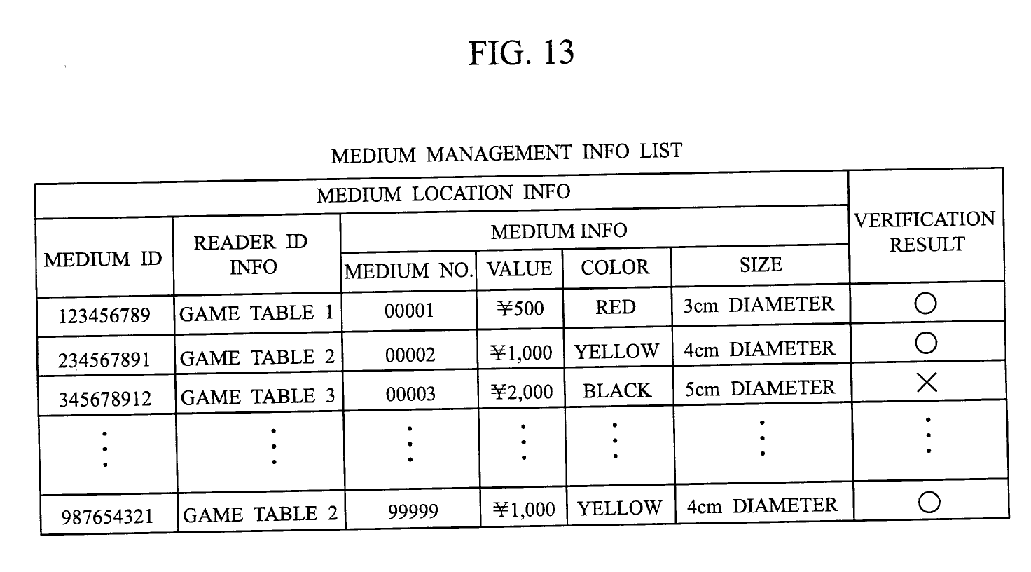

As shown in FIG. 13, the medium management information includes medium IDs, medium information, reader ID information and verification results.

More specifically, with regard to medium management information, the medium ID information is read by the medium ID information reader 61, the reader ID information uniquely identifies the medium ID information reader 61 having read the medium ID information, and the result of verification by the verifying unit 31 of the read medium ID information against the medium ID information managed by the medium ID information manager 32 are associated with one another.

The medium IDs are made of variable numbers uniquely identifying the game media 1. The medium IDs are selected, for example, from a table of random numbers.

The medium information includes information such as a medium number, value, color and size. The medium number is a fixed number uniquely identifying the game medium 1. The medium number is selected, for example, from given sequence numbers.

The reader ID information uniquely identifies the medium ID information reader 61.

The verification result is the result of verification by the verifying unit 31 of the medium ID information received from the medium ID information reader 61 against the medium ID information managed by the medium ID information manager 32.

The display 4 displays the medium management information received from the medium manager 34.

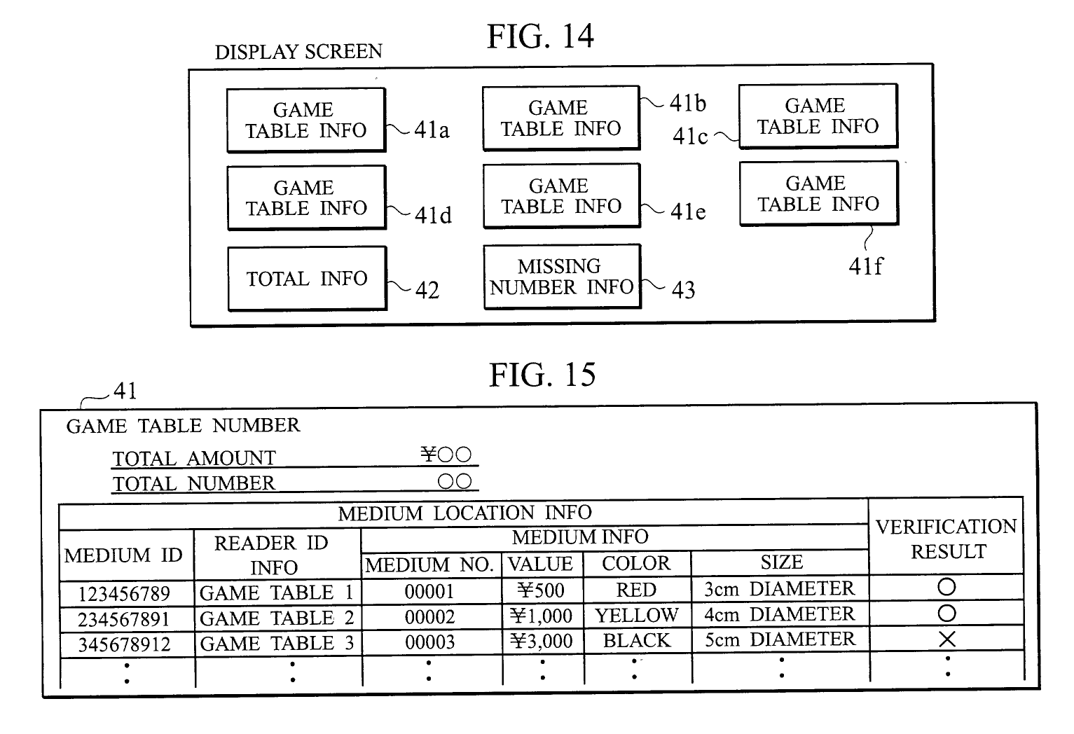

FIGS. 14 and 15 are diagrams illustrating the medium management information displayed on the display 4. As shown in FIG. 14, the display 4 displays, for example, game table information (41a to 41f), total information 42 and missing number information.

As shown in FIG. 15, the game table information 41 includes, for example, the game table number, the total amount of money, the total number of game media and medium management information.

The game table information 41 is the collection of the medium management information managed by the medium manager 34 for each game table.

The game table numbers uniquely identify the game tables 2.

The total amount of money is the result of calculation of the medium management information managed by the medium manager 34 for each game table 2. The total amount of money may be calculated for value information, color information or size information of the game media 1, for example.

The total number of game media is the result of calculation of the medium management information managed by the medium manager 34 for each game table 2. The total number of game media may be calculated for value information, color information or size information of the game media 1, for example.

The medium management information indicates the medium management information on the game media 1 managed by the game tables 2.

The total information 42 is the collection of the medium management information on the game media 1 managed by the game medium management system 10. The total information 42 is displayed in a screen similar to the game table information 41.

The missing number information 43 indicates the medium ID information of game media 1 not managed by the medium manager 34. The missing number information 43 indicates medium ID information of game media 1 missing when all the game media 1 are collected by the collector 21.

The missing number information 43 always indicates medium ID information on missing game media when the game media 1 are remain in a region communicable with the medium ID information reader 61.

The display 4 is provided at the game table 2. When provided at the game table 2, the display 4 may only display the game table information 41 on the game table 2.

The recorder 5 calculates the medium management information received from the medium manager 34 on a day-to-day basis for record. The recorder 5 may calculate the medium management information calculated on a day-to-day basis on a weekly or a monthly basis.

[Game Medium Management Method with the Game Medium Management System]

A game medium management method using the game medium management system 10 of the above configuration can be implemented through the following steps.

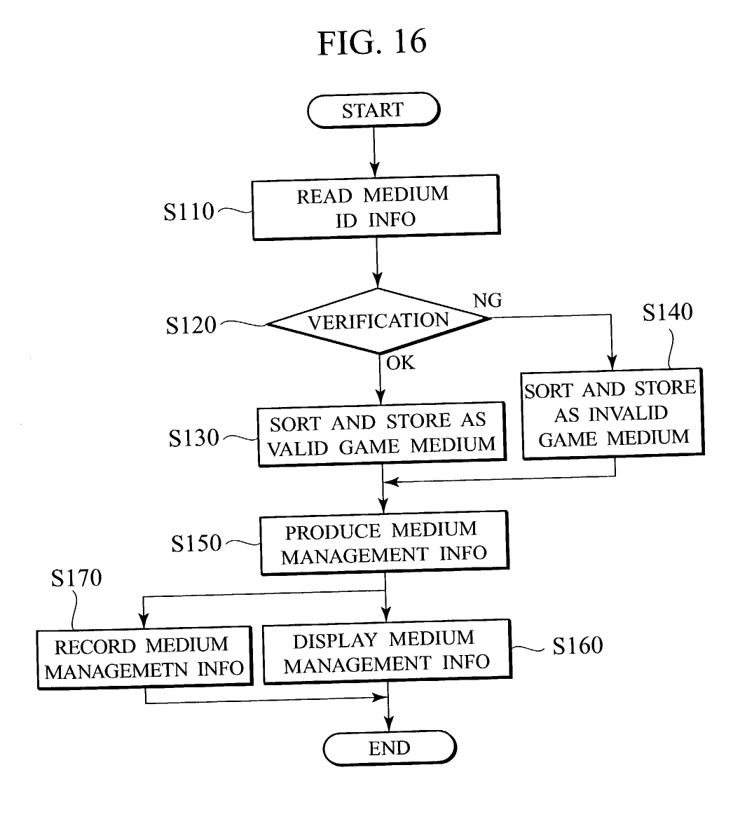

FIG. 16 is a flowchart of medium ID information reading. As shown in FIG. 16, reading of medium ID information is performed by the following steps.

In step 110, the medium ID information reader 61 reads the medium ID information stored in the game medium 1 when the game medium 1 reaches a region communicable with the medium ID information reader 61. More specifically, the medium ID information reader 61 receives the medium ID information from the medium ID information storage device 15 provided in the game medium 1 via the transceiver antenna 14. The medium ID information reader 61 transmits the medium ID information received from the medium ID information storage device 15 to the verifying unit 31.

The medium ID information reader 61 transmits the medium manager 34 the medium location information in which the medium ID information read by the medium ID information reader 61 is associated with the reader ID information uniquely identifying the medium ID information reader 61 having read the medium ID information.

In step 120, the verifying unit 31 verifies the medium ID information received from the medium ID information reader 61 against the medium ID information managed by the medium ID information manager 32.

The verifying unit 31 transmits a validation signal to the sorter 63 upon ascertaining agreement between the medium ID information received from the medium ID information reader 61 and the medium ID information managed by the medium ID information manager 32 (proceed to step 130).

The verifying unit 31 transmits an invalidation signal to the sorter 63 upon ascertaining disagreement between the medium ID information received from the medium ID information reader 61 and the medium ID information managed by the medium ID information manager 32 (proceed to step 140).

The verifying unit 31 transmits to the medium manager 34 the result of verification by the verifying unit 31 of the medium ID information received from the medium ID information reader 61 against the medium ID information managed by the medium ID information manager 32.

In step 130, the sorter 63 sorts the game medium 1 as being a valid game medium upon receiving a validation signal from the verifying unit 31. More specifically, the stopper 65 stops the game medium 1 passing through the guiding passage 64. On receiving the validation signal from the verifying unit 31, the stopper 65 releases the stopping of the game medium 1. The game medium 1 released from stopping is stored in the valid game medium storage 28.

In step 140, the sorter 63 sorts the game medium 1 as being an invalid game medium upon receiving an invalidation signal from the verifying unit 31. More specifically, the stopper 65 stops the game medium 1 passing through the guiding passage 64. On receiving the invalidation signal from the verifying unit 31, the hammer 66 flicks out the game medium 1 stopped by the stopper 65. The flicked game medium 1 drops through the dropping notch 68 and is stored in the invalid game medium storage 29.

In step 150, the medium manager 34 associates the medium location information received from the medium ID information reader 61 with the verification result received from the verifying unit 31 for storage.

More specifically, the medium manager 34 associates the medium ID information read by the medium ID information reader 61, the reader ID information uniquely identifying the medium ID information reader 61 having read the medium ID information and the result of verification by the verifying unit 31 of the read medium ID information against the medium ID information managed by the medium ID information manager 32 with one another using the medium ID information for storage.

The medium manager 34 transmits the medium management information resulting from the association to the display 4 and the recorder 5.

In step 160, the display 4 displays the medium management information received from the medium manager 34.

In step 170, the recorder 5 records the medium management information received from the medium manager 34.

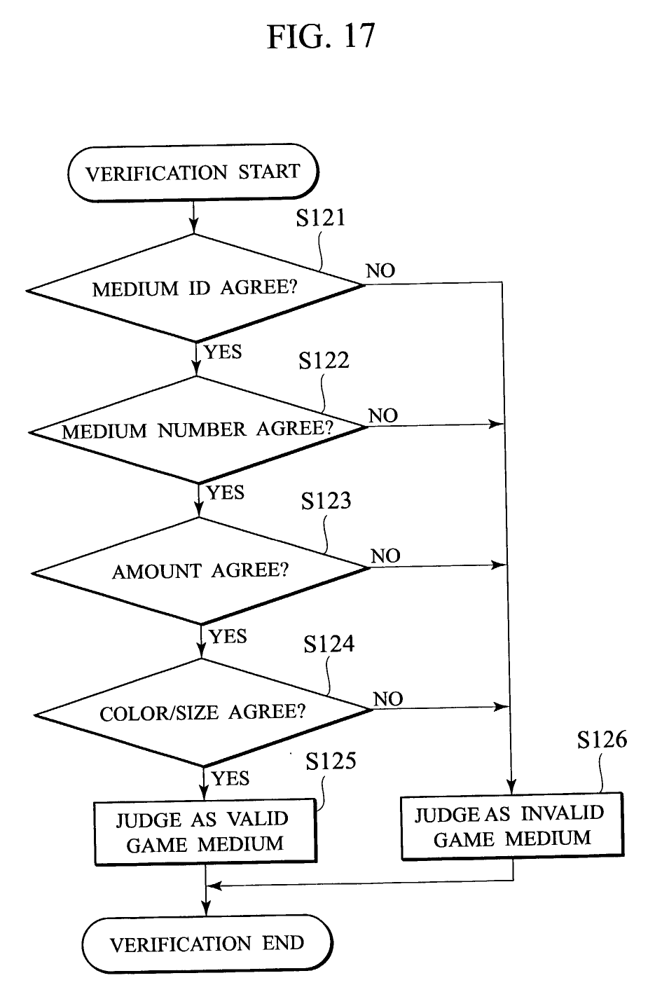

FIG. 17 is a flowchart illustrating the above step 120 in detail. As shown in FIG. 17, the above step 120 is performed through the following steps.

In step 121, the verifying unit 31 verifies the “medium ID” included in the medium ID information received from the medium ID information reader 61 against the “medium ID” included in the medium ID information managed by the medium ID information manager 32. The verifying unit 31 judges the game medium 1 as being an invalid game medium when ascertaining disagreement between the “medium IDs.”

In step 122, when agreement between the “medium IDs” included in the medium ID information is ascertained by the verifying unit 31 at step 121, the verifying unit 31 verifies the “medium number” included in the medium ID information received from the medium ID information reader 61 against the “medium number” included in the medium ID information managed by the medium ID information manager 32. The verifying unit 31 judges the game medium 1 as an invalid game medium when disagreement between the “medium numbers” is ascertained.

In step 123, when agreement between the “medium numbers” included in the medium ID information is ascertained at step 122, the verifying unit 31 verifies the “value information” included in the medium ID information received from the medium ID information reader 61 against the “value information” included in the medium ID information managed by the medium ID information manager 32. When disagreement between the “value information” is ascertained by the verifying unit 31, the verifying unit 31 judges the game medium 1 as being an invalid game medium.

In step 124, when agreement of “value information” included in the medium ID information is ascertained at step 123, the verifying unit 31 verifies the “color and size information” included in the medium ID information received from the medium ID information reader 61 against the “color and size information” included in the medium ID information managed by the medium ID information manager 32. When disagreement in the “color and size information” is ascertained, the verifying unit 31 judges the game medium 1 as being an invalid game medium.

In step 125, when ascertaining agreement in all of the “medium ID,” “medium number,” “value information” and “color and size information,” the verifying unit 31 judges the game medium 1 as being a valid game medium.

In step 126, when ascertaining disagreement in any of the “medium ID,” “medium number,” “value information” and “color and size information,” the verifying unit 31 judges the game medium 1 as an invalid game medium.

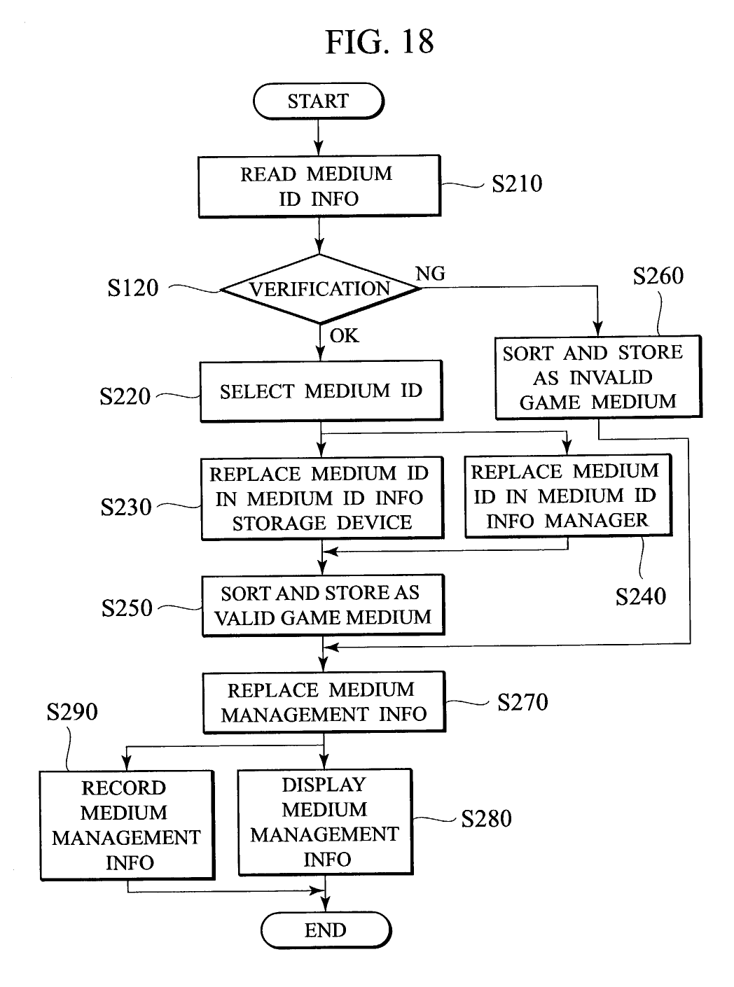

FIG. 18 is a flowchart illustrating medium ID information replacement. As shown in FIG. 18, the replacement of medium ID information is performed through the following steps.

In step 210, the medium ID information reader 61 reads the medium ID information stored in the game medium 1 when the game medium 1 reaches a region communicable with the medium ID information reader 61. Specifically, the medium ID information reader 61 receives the medium ID information from the medium ID information storage device 15 provided in the game medium 1 via the transceiver antenna 14.

The medium ID information reader 61 transmits the medium ID information received from the medium ID information storage device 15 to the verifying unit 31 and the medium ID information replacing unit 62.

The medium ID information reader 61 transmits to the medium manager 34 medium location information in which the medium ID information received from the medium ID information storage device 15 is associated with the reader ID information uniquely identifying the medium ID information reader 61 having read the medium ID information.

In step 120, the verifying unit 31 verifies the medium ID information received from the medium ID information reader 61 against the medium ID information managed by the medium ID information manager 32. Specifically, when ascertaining agreement between the medium ID information received from the medium ID information reader 61 and the medium ID information managed by the medium ID information manager 32, the verifying unit 31 transmits a validation signal to the sorter 63 and the medium ID selector 33 (proceed to step 230 and step 240).

When ascertaining disagreement between the medium ID information received from the medium ID information reader 61 and the medium ID information managed by the medium ID information manager 32, the verifying unit 31 transmits an invalidation signal to the sorter 63 (proceed to step 260).

The verifying unit 31 transmits to the medium manager 34 the result of verification of the medium ID information received from the medium ID information reader 61 against the medium ID information managed by the medium ID information manager 32.

In step 220, the medium ID selector 33 selects a medium ID not managed by the medium ID information manager 32 upon receiving the validation signal from the verifying unit 31. The medium ID selector 33 transmits the selected medium ID information to the medium ID information replacing unit 62.

In step 230, the medium ID information replacing unit 62 replaces the medium ID included in the medium ID information stored in the game medium 1 with the medium ID received from the medium ID selector 33 when the game medium 1 reaches a region communicable with the medium ID information replacing unit 62.

More specifically, the medium ID information replacing unit 62 replaces the medium ID included in the medium ID information received from the medium ID information reader 61 with the medium ID received from the medium ID selector 33 and transmits the medium ID information including the new medium ID to the medium ID information storage device 15.

The medium ID information replacing unit 62 transmits the medium ID information including the new medium ID to the medium ID information manager 32 and the medium manager 34.

The medium ID information storage device 15 replaces the stored medium ID information with the medium ID information received from the medium ID information replacing unit 62.

In step 240, the medium ID information manager 32 retrieves medium ID information matching the medium ID information received from the medium ID information replacing unit 62 from the medium ID information managed by the medium ID information manager 32. The medium ID information retrieved by the medium ID information manager 32 has a medium number identical to the medium number included in the medium ID information received from the medium ID information replacing unit 62.

The medium ID information manager 32 replaces the medium ID included in the medium ID information retrieved by the medium ID information manager 32 with the medium ID included in the medium ID information received from the medium ID information replacing unit 62.

In step 250, the sorter 63 sorts the game medium 1 as being a valid game medium upon receiving the validation signal from the verifying unit 31. Specifically, the stopper 65 stops the game medium 1 passing through the guiding passage 64. When receiving the validation signal from the verifying unit 31, the stopper 65 releases the stopping of the game medium 1. The game medium 1 released from the stopping is stored in the valid game medium storage 28.

In step 260, the sorter 63 sorts out the game medium 1 as being an invalid game medium when receiving the invalidation signal from the verifying unit 31. Specifically, the stopper 65 stops the game medium 1 passing through the guiding passage 64. The hammer 66 flicks out the game medium 1 stopped by the stopper 65 on receiving the invalidation signal from the verifying unit 31. The flicked game medium 1 drops through the dropping notch 68 and is stored in the invalid game medium storage 29.

In step 270, the medium manager 34 retrieves medium management information matching the medium ID information received from the medium ID information replacing unit 62 from the medium management information managed by the medium manager 34. The medium management information retrieved by the medium manager 34 has an medium number identical to the medium number included in the medium ID information received from the medium ID information replacing unit 62. The medium manager 34 replaces the medium ID included in the medium management information retrieved by the medium manager 34 with the medium ID included in the medium ID information received from the medium ID information replacing unit 62.

The medium manager 34 associates the medium ID information read by the medium ID information reader 61, the reader ID information uniquely identifying the medium ID information reader 61 having read the medium ID information and the result of verification by the verifying unit 31 of the read medium ID information against the medium ID information managed by the medium ID information manager 32 with one another using the medium number, for storage.

When the medium management information managed by the medium manager 34 is replaced, the medium manager 34 transmits the medium management information replaced by the medium manager 34 to the display 4 and the recorder 5.

In step 280, the display 4 displays the medium management information received from the medium manager 34.

In step 290, the recorder 5 records the medium management information received from the medium manager 34.

[Functions/Effects of the Game Medium Management System]

According to the game medium management system 10 of the present embodiment, the sorter 61 can sort forged game media as being invalid game media. This allows the game medium management system 10 to prevent the use of forged game media, preventing reduction in the earnings of the management of the game hall provided with the game tables 2.

In this embodiment, the manager managing the game media 1 can keep track of the use state of the game media 1 managed by the medium manager 34 through the display of the medium management information on the display 4. When the medium ID information of all of the game media 1 is managed by the medium manager 34, the manager managing the game media 1 can also keep track of missing game media 1 through the display of missing number information on the medium ID information of the missing game media 1 on the display 4. The medium manager 34 can manage the medium management information of all of the game media 1 because all of the game media 1 are regularly collected by the collector 21.

In this embodiment, the manager managing the game media 1 can keep track of the use state of the game media 1 for each game table 2 because the collector 21 is provided to each game table 2.

In this embodiment, the medium numbers uniquely identifying the game media 1 are selected from given sequence numbers. This allows the manager managing the game media 1 to easily find game media having medium numbers out of the given sequence numbers as being forged game media.

In this embodiment, the medium IDs uniquely identifying the game media 1 are selected from a table of random numbers. This allows the game medium management system 10 to reduce the possibility of agreement between the medium IDs included in the medium ID information managed by the medium ID information manager 32 and the medium IDs included in medium ID information stored in forged game media.

In this embodiment, the medium ID selector 33 selects a medium ID not managed by the medium ID information manager 32. This allows the game medium management system 10 to further reduce the possibility of agreement between the medium IDs included in the medium ID information managed by the medium ID information manager 32 and the medium IDs included in medium ID information stored in forged game media.

In this embodiment, the medium ID selector 33 randomly selects a medium ID not managed by the medium ID information manager 32. This allows the game medium management system 10 to further reduce the possibility of agreement between the medium IDs included in the medium ID information managed by the medium ID information manager 32 and the medium IDs included in medium ID information stored in forged game media.

In this embodiment, the display 4 is provided at each game table. The dealer dealing the cards can check the medium management information displayed on the display 4 during the game to discover the use of forged game media in an early stage.

(First Modification)

The present invention is not limited to the above embodiment and can be modified as will be described below. The following description mentions only modified points.

In this modification, a medium ID information storage device 15 associates medium ID information uniquely identifying a game medium 1 with player information uniquely identifying a player playing the game for storage. The player information includes age and sex, for example.

The player information is written when the player exchanges money for the game media 1. The player information may be erased when the game media 1 are collected by a collector 21.

More specifically, a medium ID information reader 61 receives the medium ID information and the player information stored in the medium ID information storage device 15. The medium ID information reader 61 transmits to a medium manager 34 player medium information in which the medium ID information and the player information received from the medium ID information storage device 15 are associated with reader ID information uniquely identifying the medium ID information reader 61 having received the medium ID information and the player information.

The medium manager 34 transmits the player medium information received from the medium ID information reader 61 to a recorder 5.

The recorder 5 records the player medium information received from the medium manager 34. The recorder 5 can calculate the recorded player medium information on a weekly basis or a monthly basis, for example.

The player medium information has, for example, “sex,” “age,” “poker table,” “medium ID,” “medium number,” “value,” “color” and “size” associated with one another.

This allows the manager of the game hall provided with the game tables 2 to calculate the player medium information to ascertain of the tendencies in play of the player.

(Second Modification)

The present invention is not limited to the above embodiment and can be modified as will be described below. The following description mentions only modified points.

In this modification, a game medium management system 10 includes a medium ID memory for storing medium IDs uniquely identifying game media 1, and a game medium exchanger.

The medium ID memory stores a medium ID included in medium ID information having read by a medium ID information reader 61. The medium ID memory keeps the medium ID for an arbitrary period of time and erases it after the lapse of the arbitrary period of time.

A medium ID selector 33 does not select a medium ID stored in the medium ID memory.

The game medium exchanger exchanges money with game media 1. When exchanging money with game media 1, the game medium exchanger replaces the medium ID stored in the game media 1 with the medium ID selected by the medium ID selector 33.

More specifically, a medium ID information replacing unit 62 provided in the game medium exchanger replaces the medium ID stored in the game media 1 with the medium ID selected by the medium ID selector 33 when the exchanger exchanges money with the game media 1.

Upon ascertainment of agreement between medium ID information read by the medium ID information reader 61 and medium ID information managed by a medium ID information manager 32, a verifying unit 31 verifies the medium ID included in the read medium ID information against the medium ID stored in the medium ID memory.

More specifically, when the medium ID included in the medium ID information read by the medium ID information reader 61 agrees with a medium ID stored in the medium ID memory, the verifying unit 31 judges the medium ID included in the read medium ID information as being an invalid medium ID.

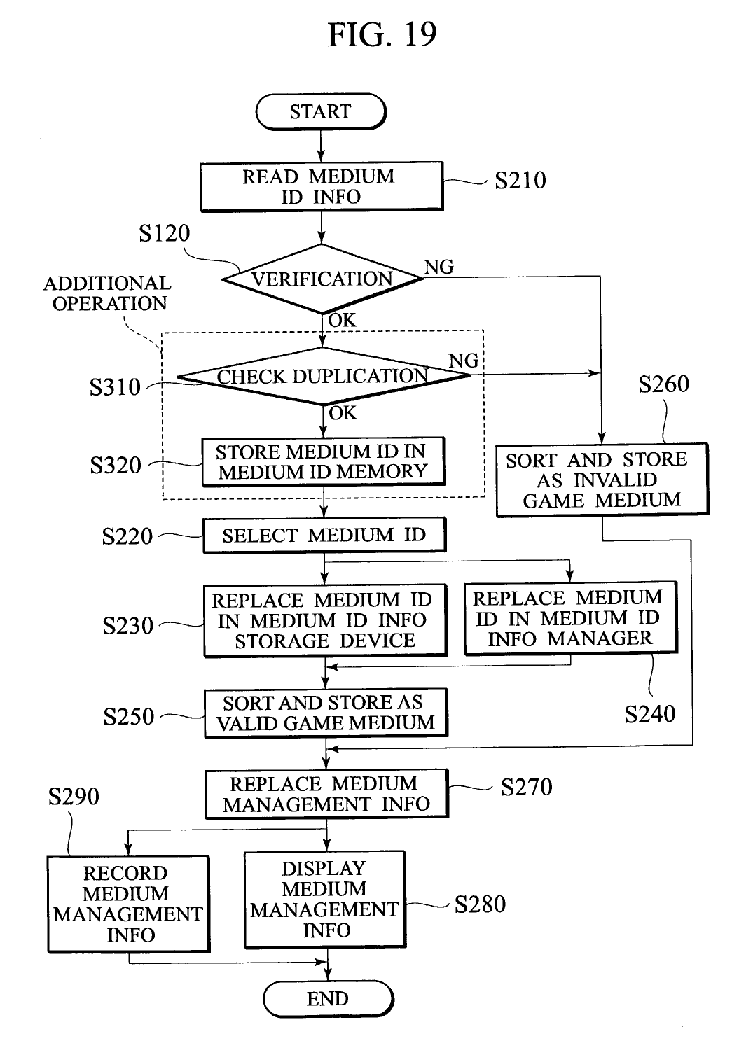

FIG. 19 is a flowchart illustrating “replacement of medium ID information” including operation added in this modification. As shown in FIG. 19, the additional operation is performed through the following steps.

In step 310, upon ascertainment of agreement between medium ID information read by the medium ID information reader 61 and medium ID information managed by the medium ID information manager 32, the verifying unit 31 verifies the medium ID included in the read medium ID information against the medium ID stored in the medium ID memory.

More specifically, upon ascertainment of agreement between the medium ID included in the read medium ID information read by the medium ID information reader 61 and a medium ID stored in the medium ID memory, the verifying unit 31 judges the medium ID included in the read medium ID information as being an invalid medium ID and transmits an invalidation signal to the sorter 63.

Also, upon ascertainment of disagreement between the medium ID included in the medium ID information read by the medium ID information reader 61 and the medium ID stored in the medium ID memory, the verifying unit 31 judges the medium ID included in the read medium ID information as being a valid medium ID and transmits a validation signal to a sorter 63.

In step 320, the verifying unit 31 stores the medium ID included in the medium ID information read by the medium ID information reader 61 in the medium ID memory.

This allows the game medium management system 10 to sort a game medium having a medium ID duplicating a medium ID stored in the medium ID memory as being an invalid game medium, further preventing the use of a forged game medium.

As described above, the game management system of this invention can prevent the use of forged game media and can keep track of the missing state of game media.

Although the present invention has been described in detail above with respect to the embodiment, it would be clear to those skilled in the art that the present invention is not limited to the embodiment described in this specification. The system of the present invention can be modified or changed for implementation without deviating from the spirit and scope of the present invention as defined in the appended claims. The description is not intended to limit the present invention but for explanatory purposes.

What is claimed is:

1. A game medium management system for managing a game medium used as a substitute for money, which system comprising:
a medium ID information storage device provided in said game medium, said storage device storing medium ID information uniquely identifying said game medium;
a medium ID information reader for reading said medium ID information stored in said medium ID information storage device;
a medium ID information manager for managing said medium ID information assigned to said game medium;
a verifying unit for verifying said medium ID information read by said medium ID information reader against said medium ID information managed by said medium ID information manager; and
a sorter for sorting said game medium as being an invalid game medium when said verifying unit ascertains disagreement between said medium ID information read by said medium ID information reader and said medium ID information managed by said medium ID information manager.

2. A game medium management system as set forth in claim 1, further comprising:
a medium manager for managing medium management information in which said medium ID information read by said medium ID information reader, reader ID information uniquely identifying said medium ID information reader having read said medium ID information, and the result of verification by said verifying unit of said read medium ID information against said medium ID information managed by said medium ID information manager are associated with one another; and
a display for displaying said medium management information managed by said medium manager.

3. A game medium management system as set forth in claim 1, wherein said medium ID information reader is provided at a game table for use in a game played with said game medium.

4. A game medium management system as set forth in claim 1, wherein:
said medium ID information comprises a medium number of a fixed number and a medium ID of a variable number; and
said medium number is selected from given sequence numbers.

5. A game medium management system as set forth in claim 4, wherein said medium ID is selected from a table of random numbers.

6. A game medium management system as set forth in claim 4, further comprising:
a medium ID selector for selecting said medium ID not managed by said medium ID information manager; and
a medium ID information replacing unit for replacing said medium ID stored in said medium ID information storage device with said medium ID selected by said medium ID selector, wherein
when said verifying unit ascertains agreement between said medium ID information read by said medium ID information reader and said medium ID information managed by said medium ID information manager, said medium ID included in said medium ID information stored in said medium ID information storage device and said medium ID included in said medium ID information managed by said medium ID information manager are replaced with said medium ID selected by said medium ID selector.

7. A game medium management system as set forth in claim 6, wherein said medium ID information replacing unit replaces said medium ID included in said medium ID information stored in said medium ID information storage device with said medium ID selected by said medium ID selector when said medium ID information stored in said medium ID information storage device is read by said medium ID information reader.

8. A game medium management system as set forth in claim 6, wherein said medium ID selector randomly selects said medium ID not managed by said medium ID information manager.

9. A game medium management system as set forth in claim 1, wherein said medium ID information reader and said sorter are provided at a collector for collecting said game medium.

10. A game medium management system as set forth in claim 6, wherein said medium ID information reader, said medium ID information replacing unit and said sorter are provided at a collector for collecting said game medium.

11. A game medium management system as set forth in claim 3, wherein said game table is provided with a collector for collecting said game medium and a display for displaying medium management information managed by a medium manager.
